(19) United States
(12) Patent Application Publication
(10) Pub. No.: US 2010/0245233 A1
(43) Pub. Date: Sep. 30, 2010

(54) MOVING AN OBJECT WITHIN A VIRTUAL ENVIRONMENT

(75) Inventors: Karl Johan Hammarling, Southam (GB); Nicholas Melder, Southam (GB)

Correspondence Address: Ostrow Kaufman & Frankl LLP;Susan Formicola, The Chrysler Building, 405 Lexington Avenue, 62nd Floor, NEW YORK, NY, 10174, US

(73) Assignee: Codemasters Software Company Ltd., Southam (GB)

(21) Appl. No.: 12/414,939

(22) Filed: Mar. 31, 2009

(51) Int. Cl. G09G 5/00

(52) U.S. Cl. 345/156

(57) ABSTRACT

A method of moving an object within a virtual environment, the method comprising: providing a reference line within the virtual environment; based on a position of the object relative to the reference line, determining a target position for the object within the virtual environment; and controlling the object so as to guide the object within the virtual environment towards the target position.

### FIELD OF THE INVENTION

The present invention relates to a method, apparatus and computer program for moving an object within a virtual environment.

### BACKGROUND OF THE INVENTION

It is well known to provide a computer game in which one or more virtual objects are located and moved within a virtual environment. The computer game may be arranged so that the computer (or games console) determines and controls the movement of one or more of these virtual objects within the virtual environment. One or more players playing the game may provide input to the computer to instruct the computer how to move one or more other virtual objects within the virtual environment. For example, the computer game may a car racing genre game, with the computer determining how to move one or more virtual (i.e. simulated) cars (i.e. determine the course, speed, acceleration, etc. of those computer-controlled cars), whilst a player of the game may control one or more other virtual cars by providing input to the computer (e.g. providing steering, braking and accelerating commands via a controller connected to the computer).

It would be desirable to provide an improvement in the way that the computer determines and controls the movement of objects within the virtual environment. In this way, more realistic object movement may be achieved and the player's enjoyment of the game can be enhanced.

### SUMMARY OF THE INVENTION

Embodiments of the invention direct or guide computer-controlled objects within a virtual environment of a computer game. This is done by referring to a reference line or a guiding line that has been defined and provided within the virtual environment. The objects do not need to strictly follow the reference line, but can be moved around the reference line. Thus, the large-scale movement of an object may be broadly viewed as following the reference line, whilst the small-scale movement of the object may be seen as being less linked to the reference line. Embodiments of the invention provide different ways in which the amount of displacement or deviation of a virtual object from the reference line is varied over time as the object is moved in the virtual environment along next to the reference line. In this way, more variety and unpredictability can be introduced into the movement of computer-controlled objects within the virtual environment, thereby providing more realistic object movement and enhancing the player's enjoyment of the game.

According to a first aspect of the invention, there is provided a method of moving an object within a virtual environment of a computer game, the method comprising: providing a reference line within the virtual environment; based on a current position of the object relative to the reference line, determining a target position for the object relative to the reference line within the virtual environment; and controlling the object so as to guide the object within the virtual environment towards the target position.

Determining the target position may comprise: determining, based on the current position of the object within the virtual environment, a first position along the reference line corresponding to the current position; determining, based on the first position, a second position along the reference line; and determining the target position to be a target distance away from the second position.

The first position along the reference line may be determined to be a position along the reference line for which a straight line from the first position to the current position is perpendicular to the reference line.

The method may comprise determining a desired distance along the reference line from the first position to the second position, wherein the second position is determined to be a position along the reference line that is the desired distance along the reference line from the first position.

Determining the desired distance may be dependent upon a speed of the object within the virtual environment and/or upon a curvature of the reference line. In particular, a desired distance determined in dependence upon a first curvature may be larger than a desired distance determined in dependence upon a second curvature larger than the first curvature.

The method may comprise determining the target distance. Determining the target distance may be based, at least in part, upon one or more of: the distance between the current position and the first position; a property of the object; a property of the virtual environment; the location of one or more additional objects within the virtual environment; and a random number. The target distance may be determined to be at most a predetermined threshold from the distance between the current position and the first position.

Determining the target position may comprise determining a target vector that starts at the second position and has a magnitude of the target distance, the target position being at the end of the target vector. The target vector may be based, at least in part, upon one or more of: the vector from the first position to the current position; a property of the object; a property of the virtual environment; the location of one or more additional objections within the virtual environment; and a random number.

The method may comprise selecting the reference line from a plurality of reference lines.

Providing a reference line may comprise providing data defining a line along a virtual surface within the virtual environment.

According to a second aspect of the invention, there is provided a method of moving a plurality of objects within a virtual environment, the method comprising: for each of the plurality of objects, carrying out one of the above-mentioned methods to move that object.

According to a third aspect of the invention, there is provided a method of providing a computer game, the method comprising: for each of a series of images for the computer game: moving an object within a virtual environment for the computer game by carrying out a method according to the above-mentioned first aspect of the invention; generating that image as an image representing at least a part of the virtual environment, based at least in part on the position of the object within the virtual environment; and outputting that image.

According to a fourth aspect of the invention, there is provided a computer readable medium storing a computer program for a computer game which, when executed by a computer, causes the computer to move an object within a virtual environment of the computer game by: providing a reference line within the virtual environment; based on a current position of the object relative to the reference line, determining a target position for the object relative to the reference line within the virtual environment; and controlling the object so as to guide the object within the virtual environment towards the target position.

Determining the target position may comprise: determining, based on the current position of the object within the virtual environment, a first position along the reference line corresponding to the current position; determining, based on the first position, a second position along the reference line; and determining the target position to be a target distance away from the second position.

According to a fifth aspect of the invention, there is provided an apparatus arranged to move an object within a virtual environment of a computer game, the apparatus comprising: a memory storing data defining a reference line within the virtual environment; and a processor comprising: a target position determination module arranged to determine a target position for the object relative to the reference line within the virtual environment based on a current position of the object relative to the reference line; and an object moving module arranged to control the object so as to guide the object within the virtual environment towards the target position.

The target position determination module may be arranged to determine the target position by: determining, based on the current position of the object within the virtual environment, a first position along the reference line corresponding to the current position; determining, based on the first position, a second position along the reference line; and determining the target position to be a target distance away from the second position.

According to a sixth aspect of the invention, there is provided a method of providing a computer game in which one or more objects are moved within a virtual environment of the computer game, the method comprising: for each of a series of images to be displayed for the computer game: for each of the one or more objects; determining a target position for that object within the virtual environment based on the position of that object relative to a reference line within the virtual environment, there being one or more reference lines available; and updating the current position for that object within the virtual environment to represent movement of that object towards the target position; generating an image representing the virtual environment based, at least in part, on the updated current positions; and displaying the generated image.

The reference line may represent a line along a surface of a virtual road within the virtual environment and the one or more objects within the virtual environment may represent virtual vehicles for travelling along the virtual road.

According to a seventh aspect of the invention, there is provided a computer readable medium storing a computer program which, when executed by a computer, causes the computer to provide a computer game in which one or more objects are moved within a virtual environment of the computer game by: for each of a series of images to be displayed for the computer game: for each of the one or more objects; determining a target position for that object within the virtual environment based on the position of that object relative to a reference line within the virtual environment, there being one or more reference lines available; and updating the current position for that object within the virtual environment to represent movement of that object towards the target position; generating an image representing the virtual environment based, at least in part, on the updated current positions; and displaying the generated image.

The reference line may represent a line along a surface of a virtual road within the virtual environment and the one or more objects within the virtual environment may represent virtual vehicles for travelling along the virtual road.

### BRIEF DESCRIPTION OF THE DRAWINGS

Embodiments of the invention will now be described, by way of example only, with reference to the accompanying drawings, in which:

FIG. 1 schematically illustrates a system according to an embodiment of the invention;

FIG. 2 schematically illustrates part of a road within a virtual environment for a racing game;

FIG. 3 schematically illustrates a section of a reference line;

FIG. 4 is a flowchart illustrating a method according to an embodiment of the invention;

FIG. 5 schematically illustrates modules and data used for implementing embodiments of the invention; and

FIG. 6 is a flowchart illustrating a method according to another embodiment of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

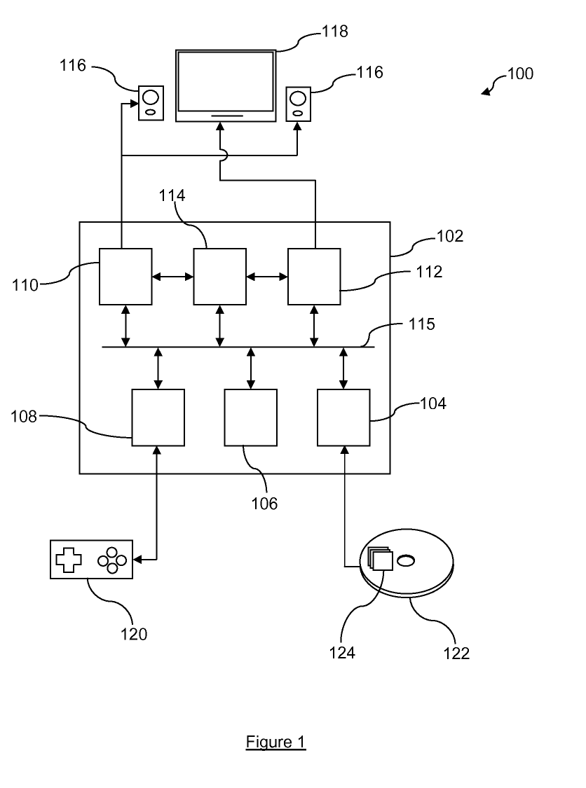

FIG. 1 schematically illustrates a system 100 according to an embodiment of the invention. The system 100 comprises a games console 102 that is arranged to execute and provide a computer game to a user (player), so that a user of the games console 102 can play the game. As discussed in more detail below, the games console 102 may interface and communicate with a number of peripheral devices external to the games console 102 to facilitate execution and operation of the computer game.

The games console 102 comprises a media interface 104, a processor 106, a controller interface 108, an audio processing unit 110, a graphics processing unit 112 and a memory 114, which may communicate with each other via a bus 1 15. Additionally, the audio processing unit 110 and the graphics processing unit 112 may read data from, and store (or write) data to, the memory 114 directly, i.e. without having to use the bus 115, in order to improve the data access rate.

The media interface 104 is arranged to read data from a storage medium 122, which may be a removable storage medium such as a CD-ROM, a DVD-ROM, a Blu-Ray disc, a FLASH memory device, etc. In particular, the media interface 104 may read one or more computer programs 124 that are stored on the storage medium 122. The media interface 104 may also read other data, such as music or video files (not shown) that may be stored on the storage medium 122. The programs 124 and other data read from the storage medium 122 may be stored in the memory 114 or may be communicated via the bus 115 directly to one or more of the elements of the games console 102 for use by those elements. The media interface 104 may perform these operations automatically itself, or it may perform these operations when instructed to do so by one of the elements of the games console 102 (e.g. the audio processing unit 110 may instruct the media interface 104 to read audio data from the storage medium 122 when the audio processing unit 110 requires certain audio data).

The computer programs 124 may comprise program instructions or code which, when executed by the games console 102, cause the games console 102 to carry out embodiments of the invention. In particular, the processor 106 and/or the audio processing unit 110 and/or the graphics processing unit 112 may execute one or more of the computer programs 124 in order to provide the game to the user.

The processor 106 may be any processor suitable for carrying out embodiments of the invention. To do this, the processor 106 may cooperate with the audio processing unit 110 and the graphics processing unit 112. The audio processing unit 110 is a processor specifically designed and optimised for processing audio data. The audio processing unit 110 may read audio data from the memory 114 and/or the storage medium 122, or may generate audio data itself, and may then provide a corresponding audio output signal (e.g. with sound effects, music, speech, etc.) to one or more speakers 116 to provide an audio output to the user. Similarly, the graphics processing unit 112 is a processor specifically designed and optimised for processing video (or image) data. The graphics processing unit 112 may read image/video data from the memory 114 and/or the storage medium 122, or may generate image/video data itself, and may then provide a corresponding video output signal (e.g. a series of video fields or frames according to a video format) to a display unit 118 (e.g. a screen or monitor).

Whilst the speakers 116 are shown as being separate from the display unit 118 in FIG. 1, it will be appreciated that the speakers 116 may be integral with the display unit 118. Additionally, whilst the speakers 116 and the display unit 118 are shown as being separate from the games console 102 in FIG. 1, it will be appreciated that the speakers 116 and/or the display unit 118 may be integral with the games console 102.

The user may interact with the games console 102 using one or more game controllers 120. A variety of game controllers are known and available, and they shall not be described in detail herein. The controller interface 108 is arranged to receive input signals from the game controller 120, these signals being generated by the game controller 120 based on how the user interacts with the game controller 120 (e.g. by pressing buttons on the game controller 120). The controller interface 108 passes these input signals to the processor 106 so that the processor 106 can coordinate and provide the game in accordance with the commands issued by the user via the game controller 120. Additionally, the controller interface 108 may provide output signals to the game controller 120 (e.g. to instruct the game controller 120 to output a sound or to vibrate) based on instructions received by the controller interface 108 from the processor 106.

Whilst the game controller 120 is shown as being separate from the games console 102 in FIG. 1, it will be appreciated that the game controller 120 may be integral with the games console 102.

Embodiments of the invention relate to computer games in which one or more virtual objects are located within a virtual environment of, and provided by, the computer game. The term “virtual environment” means a simulation or representation of a part of a real physical, or an imaginary, universe, world, space, place, location or area, i.e. the virtual environment represents and provides a computer-generated arena in which the game is to be played. The term “virtual object” then refers to a simulation or representation of an object, item or article present and located within the simulated arena of the virtual environment.

In such games, the games console 102 (under the control of the processor 106 executing one or more instructions provided by one or more computer programs 124) determines and controls the movement of one or more of the virtual objects within the virtual environment, e.g. in terms of the path, speed, acceleration, etc. of those objects. In other words, embodiments of the invention provide a method of moving an object within a virtual environment. These objects shall be referred to as computer-controlled objects (although they may also be referred to as robot objects). Additionally, the user may be responsible for controlling (via the game controller 120) the movement of one or more other virtual objects within the virtual environment. Such objects shall be referred to as player-controlled objects.

For example:
The virtual environment could represent one or more buildings (which may be fictitious) and the virtual objects could comprise computer-controlled objects representing enemy soldiers that are to be moved within and around the simulated buildings, as well as a player-controlled object representing a player's character.
The virtual environment could represent outer space (with planets, stars, etc.) and the virtual objects could comprise computer-controlled objects representing spacecraft and meteors that are to be moved within the virtual environment, as well as a player-controlled object representing a player's spaceship.
The virtual environment could represent an ocean or other body of water (or the air), and the virtual objects could represent objects such as fish, boats, submarines etc. (or birds, aeroplanes and helicopters etc.).
The virtual environment could represent a racing course and the virtual objects may comprise computer-controlled and player-controlled objects representing objects to be raced along the race course. The race course could be a racing course for vehicles (such as cars, lorries, motorcycles, aeroplanes, etc.), with the virtual objects then representing cars, lorries, motorcycles, aeroplanes, etc. accordingly. Alternatively, the racing course could be a racing course for animals (such as horses or greyhounds), with the objects then representing the corresponding animal.

In general, though, embodiments of the invention provide a method of controlling the movement of an object within a virtual environment, i.e. embodiments of the invention provide a method for determining how to move a virtual computer-controlled object within the virtual environment. This may be carried out by the processor 106 executing one or more of the computer programs 124 based on data stored in the memory 114 and/or the storage medium 122.

For this, one or more predetermined reference lines within the virtual environment are defined or provided. For example, a computer program 124 may include data defining one or more of these reference lines. The movement of a computer-controlled object within the virtual environment is then controlled based on one of these reference lines (although the choice of reference line may change over time), i.e. embodiments of the invention move an object within the virtual environment with reference to one of the one or more reference lines.

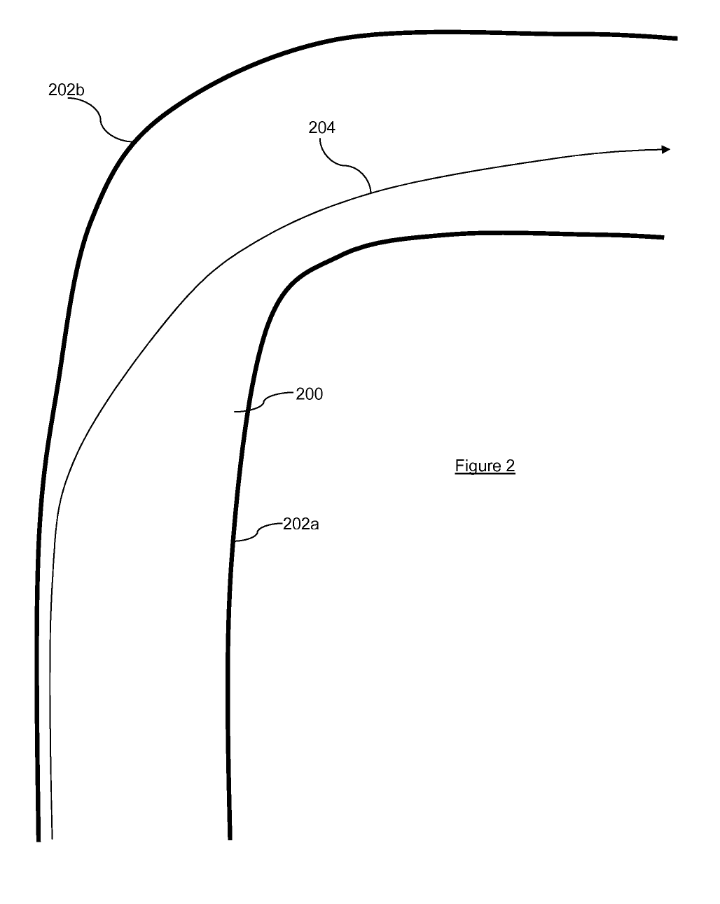

FIG. 2 schematically illustrates part of a virtual road 200 within a virtual environment for a racing genre game. The road 200 has a right edge 202a and a left edge 202b. A reference line 204 along the surface of the road 200 is provided for the computer game. The virtual objects for the computer game may then represent vehicles (e.g. cars, motorcycles, etc.) for travelling along the virtual road 200.

This reference line 204 may represent a so-called “racing line”, i.e. a trajectory or route along the road 200 that maximises the speed with which an object may travel along the road 200 (or minimises the time taken to travel along the road 200). The reference line 204 may represent a so-called “overtaking line”, i.e. a trajectory or route along the road 200 that increases the likelihood that an object which is following the overtaking line is able to overtake or pass an object which is not following the overtaking line. Other reference lines 204 may be provided and defined, and they may represent courses or paths with other properties or intentions depending on the requirements and nature of the computer game.

In general, though, a reference line 204 provides an approximate route (track, course, path, trajectory) intended to be used as a guide for determining how to move one or more computer-controlled objects within the virtual environment. The processor 106 need not determine that a computer-controlled object will follow the reference line 204 precisely. However, the processor 106 may use the reference line 204 as a basis for determining a course for one or more computer-controlled objects.

It will be appreciated that embodiments of the invention are not restricted to using roads 200 that have boundaries 202a or 202b. It will also be appreciated that the reference line 204 need not be provided on the surface of a road 200, but could be a line on any surface provided within the virtual environment by the game (such as the surface of a planet, the floor of a building, etc.). It will also be appreciated that the reference line 204 need not be a line on a surface within the virtual environment, but may rather be a line independent of the surfaces within the virtual environment, for example a line in the air (or another gas), a line within a body of liquid (e.g. a sea or an ocean) or a line in space. In general, then, the reference line 204 may be any line within the virtual environment that is suitable for the game and the intended purpose of the reference line 204 (e.g. a racing line).

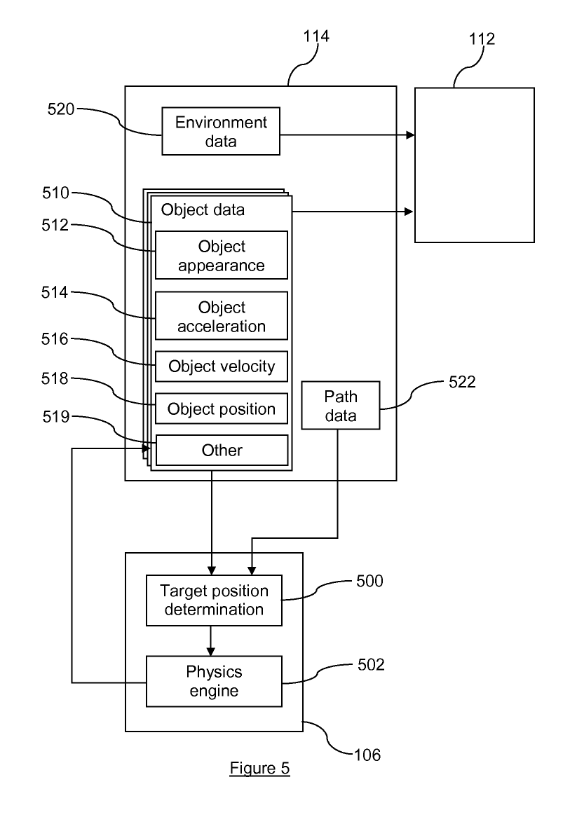

FIG. 5 schematically illustrates modules and data used for implementing embodiments of the invention.

For each of the objects within the virtual environment, the memory 114 stores corresponding object data 510. The object data 510 describes, or represents, one or more properties of the corresponding object. For example, the object data 510 may include: object appearance data 512 that is data about how the object should be displayed (e.g. colour, size, texture, etc.); object acceleration data 514 that represents the acceleration of the object within the virtual environment; object velocity data 516 that represents the speed or velocity of the object within the virtual environment; object position data 518 that represents the current location of the object within the virtual environment (e.g. by storing two-dimensional or three-dimensional coordinates in a two-dimensional or three-dimensional coordinate system for the virtual environment); and potentially other object-related data 519 (e.g. a steering angle for an object representing a vehicle; an angle of pitch, roll or yaw for an object representing an aircraft, etc.).

The memory 114 also stores environment data 520 representing properties of the virtual environment (e.g. the location, colour, texture and size of buildings, roads, planets, non-moving objects within the virtual environment, etc.).

The memory 114 also stores path data 522 representing and defining the one or more predetermined reference lines (e.g. by using data defining one or more of curves, splines, coordinates, curvatures, angles, positions along surfaces, etc.). In this way, one or more reference lines within the virtual environment are provided and defined.

It will be appreciated that some or all of the above-mentioned data may be initially read from the storage medium 122 and stored in the memory 114 (e.g. when initially loading the game). It will also be appreciated that the memory 114 may not store all of this data; rather some or all of it (in particular the non-changing or static data such as the path data 522) may be stored on, and read from, the storage medium 122 instead of being stored in, and read from, the memory 114.

The processor 106 is arranged to execute a target position determination module 500 and a physics engine 502. One or both of these components (i.e. the target position determination module 500 and the physics engine 502) may be provided by one or more of the computer programs 124 or may be predetermined hardware modules/components of the processor 106.

As will be described in more detail later, for a given object, the target position determination module 500 reads the object position data 518 for that object and the path data 522 for a reference line from the memory 114 and uses this data to determine a target position towards which that object should be guided (or moved or directed). In particular, based on the position of the object relative to the reference line, the target position determination module 500 determines a target position for the object within the virtual environment. The physics engine 502 receives the target position and the current position for the object from the target position determination module 500 and calculates how to cause the object to be guided towards the target position from its current position, e.g. by changing its speed, acceleration, orientation, steering, etc. Thus, the physics module 502 acts as an object guidance module or an object moving module for controlling the object so as to guide the object within the virtual environment towards the target position. The physics module 502 may use, for example, the object acceleration data 514, the object velocity data 516, the object position data 518, the target position, and the environment data, along with predetermined physical laws (e.g. representations of Newtonian mechanics) to determine, for example, what (virtual) forces need to be applied to the object or how the characteristics of the object (e.g. steering angle) need to be changed so that the object moves towards the target position. The physics module 502 then updates the object data 510 for that object accordingly.

The graphics processing unit 112 uses the environment data and the object data 510 (such as the object appearance data 512 and the object position data 518) to generate and render an image representing the virtual environment with the one or more objects located therein.

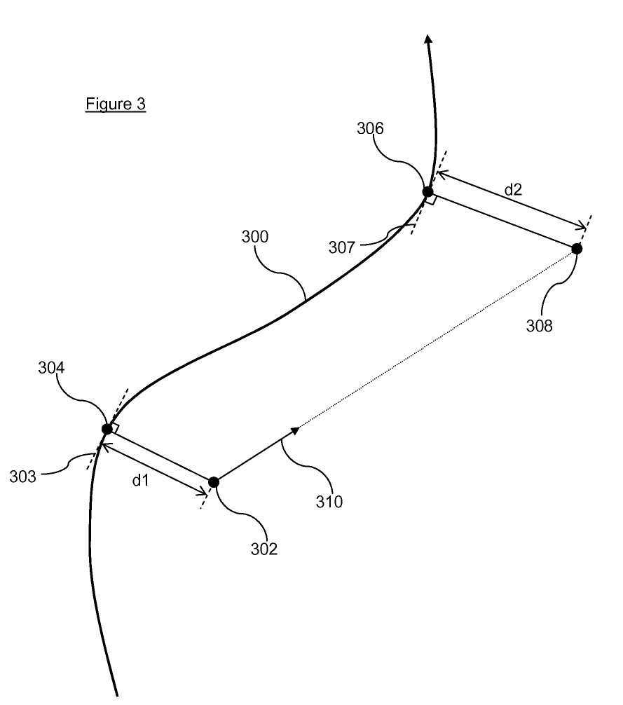

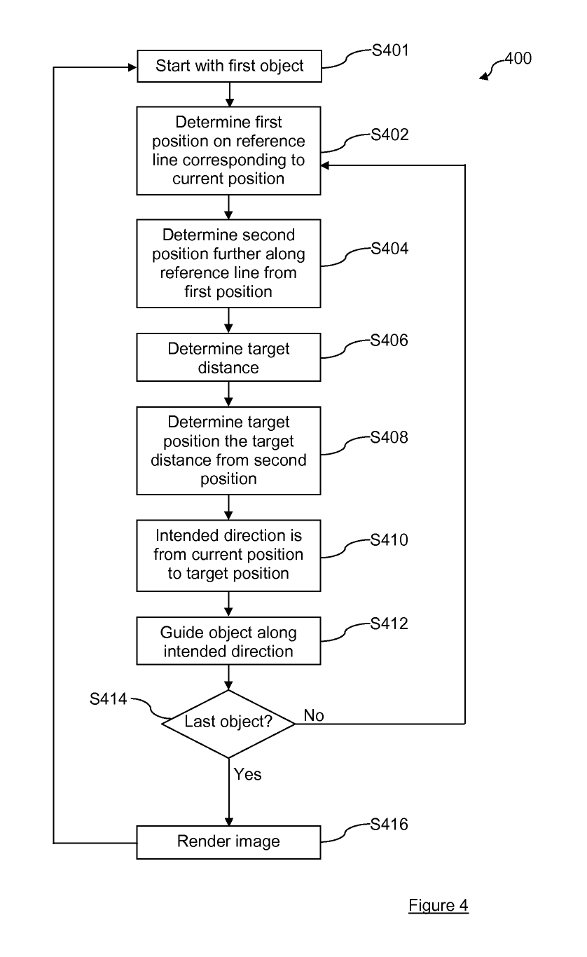

A description of the above-mentioned process is provided below with reference to FIGS. 3 and 4. FIG. 3 schematically illustrates a section of a reference line 300. FIG. 4 is a flowchart illustrating a method 400 according to an embodiment of the invention.

At a step S401, the method 400 begins with a first one of the one or more objects within the virtual environment.

At a step S402, the target position determination module 500 accesses the object position data 518 for an object, as well as the path data 522 for a reference line 300. If a plurality of reference lines are available, then one of the reference lines is selected by the processor 106 and the path data 522 corresponding to that selected reference line 300 is read from the memory 114. For example, if two reference lines are provided with one representing an “overtaking line” and the other representing a “racing line”, then the processor 106 may select the overtaking line for the object if there are one or more other objects that are close ahead of the current object, with the racing line being selected otherwise. This may depend, in part, on some of the other object data 519 (e.g. data representing a level of willingness for that object to try to overtake other objects). However, it will be appreciated that various factors may be used to select the reference line (e.g. the reference line closest to the object may be selected, or the selection may be random, or the selection may change at certain times within the game, etc.).

Using this data, the target position determination module 500 determines, based on the current position 302 of the object within the virtual environment (as indicated by the object position data 518), a first position 304 along the reference line 300 (represented by the path data 522) that corresponds to the current position 302.

The processing for the step S402 may involve determining a point 304 along the reference line 300 for which a straight line joining the current position 302 and the point 304 is normal (or perpendicular) to the reference line 300, i.e. is normal (or perpendicular) to the tangent 303 to the reference line 300 at the point 304. For three-dimensional virtual environments, this could involve determining a point 304 along the reference line 300 for which a line joining the current position 302 and the point 304 is normal to the plane that is tangential to the reference line 300 at the point 304. Alternatively, the processing for the step S402 may simply involve determining which point 304 along the reference line 300 is closest to the current position 302 (i.e. for which the distance d1 in FIG. 3 is the smallest).

At a step S404, the target position determination module 500 determines, based on the first position 304, a second position 306 along the reference line 300. This second position 306 is along the reference line 300 from the first position 304 in the general direction of travel of the object (e.g. in FIG. 3, upwards along the reference line 300).

The second position 306 may be chosen such that it is a certain distance D away from the first position 304. This distance D may be a straight-line distance between the first position 304 and the second position 306, or it may be a distance along the reference line 300.

The distance D may be a predetermined distance.

Alternatively, the processing at the step S404 may comprise determining a desired distance D along the reference line 300 from the first position 304 to the second position 306, wherein the second position 306 is determined to be a position along the reference line 300 that is the desired distance D along the reference line 300 from the first position 304.

This desired distance D may be dependent upon the speed of the object within the virtual environment (as indicated by the object velocity data 516). For example, the desired distance D may increase as the speed of the object increases (this is desirable, since the faster the object is moving within the virtual environment, the more distance it will have moved relative to the reference line 300 between displaying consecutive video frames). Thus, the processing at the step S404 may comprise determining a speed for the object (e.g. by accessing the object velocity data 516) and calculating the desired distance D from the speed (e.g. by scaling a predetermined distance by the speed, or by using a lookup table associating distances with speeds, or using some other function).

Additionally, or alternatively, the desired distance D may be dependent upon a curvature (or radius of curvature) of the reference line 300. This may be the curvature of the reference line 300 at the first position 304 or may be the largest or smallest curvature of the reference line 300 between the first position 304 and the second position 306. The desired distance D may decrease as the curvature increases, so that the desired distance D determined based upon a first curvature of the reference line 300 is larger than the desired distance D that is determined based upon a second curvature of the reference line 300 that is larger than the first curvature. Thus, the processing at the step S404 may comprise determining (or accessing from the memory 114) one or more indications of the curvatures for the reference line 300 and calculating the desired distance D from these indications. These indications may form part of the path data 522, e.g. the curvatures or radii of curvature for the reference line 300 may be stored as part of the path data 522.

At a step S406, the target position determination module 500 determines a target distance d2. The target distance d2 represents a distance away from the reference line 300 for a target position 308 (which will be determined at a step S408—described below), where the target position 308 is a position within the virtual environment towards which the object will be guided, directed or moved from the current position 302.

The target distance d2 may be a predetermined distance, and hence this step S406 may be considered as optional, e.g. the predetermined distance may be a constant value stored in and accessed from the memory 114.

The target distance d2 may be dependent, at least in part, upon the distance d1 (i.e. the distance between the current position 302 and the first position 304). For example, the target distance d2 may be constrained to be within a predetermined threshold of the distance d1, i.e. the target distance d2 may be constrained such that d1−t≦d2≦d1+t for some threshold distance t. The actual choice of the value of d2 may then be made randomly within this range of values. In this way, a smoother transition between the distances d1 and d2 is achieved.

The target distance d2 may be dependent, at least in part, upon a property (or feature or characteristic) of the object whose movement is being determined and controlled (e.g. as represented by the other object data 519). For example, each computer-controlled object may have its own corresponding upper-bound on the distances d1 and d2, i.e. its own threshold dmax, so that d1 and d2 are constrained such that d1≦dmax and d2≦dmax. For example, in a car-racing game, a car with a simulated “good driver” may have a small value for dmax, so that that car is controlled to move very close to the reference line 300 (e.g. very close to a racing line), whereas a car with a simulated “bad driver” may have a larger value for dmax, so that that car may move further away from the reference line 300 (e.g. not following the racing line quite as well as the car with the “good driver”). Additionally, or alternatively, the value of dmax may be dependent on the (virtual) aerodynamics of the object, and the processor 106 may vary the value for dmax during the game itself based on changes to the aerodynamics of the object (e.g. due to damage to the object resulting from a collision within the virtual environment). Additionally, or alternatively, each computer-controlled object may have an “erratic” or “unpredictability” property, which affects the above-mentioned threshold value t (e.g. the more erratic the movement is to be, the larger the value of t). Additionally, or alternatively, each object may have its own “manoeuvrability” properties, that specify how quickly, or to what extent, the trajectory of the object can be changed. Then, the above-mentioned threshold t may be higher for objects whose manoeuvrability is higher. As such, the processing at the step S406 may involve reading and using the other object data 519, and adjusting or determining the target distance d2 accordingly.

Furthermore, the target distance d2 may be dependent, at least in part, upon the proximity or location of one or more additional objects within the virtual environment or features or properties of the virtual environment. For example, in the embodiment shown in FIG. 2, the objects are being moved along the road 200. In this case, the distance d2 may be constrained so that the target position 308 is a position on the road, i.e. is not beyond the right edge 202a or the left edge 202b. Additionally, or alternatively, if there is another virtual object within the virtual environment that is close to the present object, and if it is desirable to avoid a collision between these two objects, then the target distance d2 may be constrained so that movement of the present object along a path between the current position 302 and the target position 308 would avoid the other virtual object. As such, the processing at the step S406 may involve reading and using the object position data 518 for other objects and/or environment data 520, and adjusting or determining the target distance d2 accordingly.

As mentioned above, the target distance d2 may be determined, at least in part, based on a random number. For example, the target distance d2 may be a random number in the above-mentioned ranged from d1−t to d2+t. Alternatively, the target distance d2 may be a random number in a predetermined range from c1 to c2, where c1 and c2 are predetermined constants.

It will be appreciated that other factors may be involved in determining the target distance d2.

Some of the above factors and processing may take precedence over other factors when determining the target distance d2. For example, keeping an object on the road 200 in FIG. 2 may take precedence over all other factors.

It will be appreciated that the target distance d2 may be determined so that the target position 308 is on a different side of the reference line 300 than current position 302, as opposed to being on the same side as shown in FIG. 3. This could be represented, for example, by using positive distances for one side of the reference line 300 and negative distances for the other side of the reference line 300. Alternatively, the distance could always be non-negative, and another variable could be used to indicate the relative positioning of the object and the reference line 300.

At the step S408, the target position determination module 500 determines the target position 308, i.e. a location in the virtual environment that is the target distance d2 away from the second position 306 is determined.

The processing for the step S408 may involve determining a point 308 a distance d2 along a line that is normal (or perpendicular) to the reference line 300 at the second position 306, i.e. is normal (or perpendicular) to the tangent 307 to the reference line 300 at the second position 306. For three-dimensional virtual environments, this may involve determining a point 308 a distance d2 along a line from the second point 306 that is normal to the plane that is tangential to the reference line 300 at the point 306. Alternatively, the processing for the step S402 may be constrained by other factors of the virtual environment, e.g. the target position 408 may be constrained to be on a surface defined within the virtual environment. For example, in a car-racing game using the road 200 of FIG. 2 (which may be a road 200 with changes in altitude or elevation), then the processing for the step S408 may involve determining a point 308 on the surface of the road 200 (or the surrounding ground) that is the target distance d2 away from the second position 306.

Once the target position 308 has been determined, then, at a step S410, the physics engine 502 determines the intended direction of travel for the object, i.e. the vector 310 from the current position 302 to the target position 308.

Based on this intended direction, at a step S412, the physics engine 502 controls the object so as to guide or direct the object within the virtual environment from the current position 302 towards the target position 308. This may be achieved, for example, by controlling properties of the object such as speed, angle of steering, attitude, etc. The ability to guide an object within a virtual environment from a current position 302 towards a target position 308 is well known and shall therefore not be described in more detail herein. The physics engine 502 updates the current position 302 of the object, along with other properties of the object (such as velocity, steering angle, acceleration, etc.), by updating the object data 510 for that object accordingly, to thereby represent movement of the object towards the target position 308.

It will be appreciated that the object need not actually reach or arrive at the target position 308 within the time corresponding to the next image that is to be output on the display 118 for the computer game, and that the target position 308 may have moved when the processing 400 is performed for the subsequent image to be output.

At a step S414, the processor 106 determines whether there are any more objects in the virtual environment whose movement needs to be controlled and whose position needs to be updated. If there is another such object, then processing returns to the step S402 in respect of that object; otherwise processing proceeds to a step S416. Hence, the steps S402-S412 may be repeated for each of a plurality of objects within the virtual environment.

At the step S416, the games console 202 renders (or outputs) an image for presentation to the user via the display 118. For this the graphics processing unit 112 generates an image that represents the virtual environment, based on the object data 510 (including the updated object position data 518 reflecting the updated current position of the object) and the environment data 520. This image is then output as a video frame or field to the display 118. In this way, the computer game is provided by performing, for each of a series of images for the computer game: moving one or more objects within the virtual environment for the computer game; generating that image as an image representing at least a part (or a current view) of the virtual environment, based at least in part on the (updated) position(s) of the object(s) within the virtual environment; and outputting that image.

Processing then returns to the step S401, so that the current position(s) 302 can be updated again for the next video field or frame.

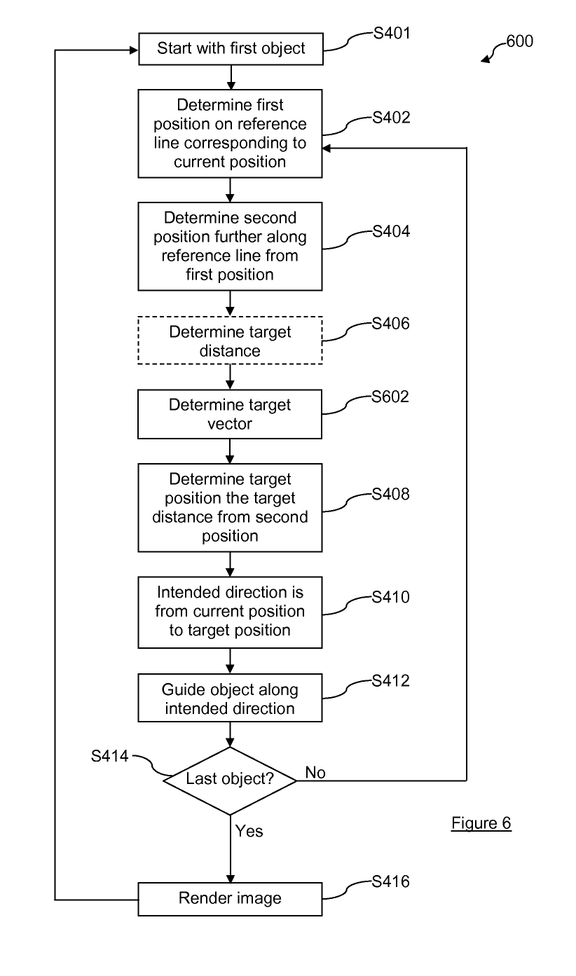

FIG. 6 is a flowchart illustrating another method 600 according to an embodiment of the invention. The method 600 is very similar to that of the method 400 of FIG. 4 and involves using some of the same steps as the method 400 of FIG. 4. In FIG. 6, such steps have been given the same reference numerals as used in FIG. 4, and they shall not be described again in any detail.

The method 600 is applicable to virtual environments and computer games in which virtual objects are not constrained to be moved along a surface (such as the surface of the road 200 in FIG. 2). For example, virtual objects representing spacecraft moving in outer space or aircraft flying in the air may not be constrained to move along a surface, but may instead be able to move freely in all three dimensions of the virtual environment.

The method 600 may involve all of the steps of the method 400 of FIG. 4. However, the step S406 may be optional, as the target distance d2 may simply be a predetermined distance in the method 600. Hence, the step S406 is shown with dashed lines in FIG. 6.

However, the method 600 also comprises a step S602 of determining a target vector. The target vector is the vector in the three-dimensional virtual environment from the second point 306 to the target point 308, and has a magnitude of the target distance d2. However, at the step S602, the angles of the target vector around the second point 306 are determined (e.g. the angles in a spherical coordinate system centred on the second point 306). In some embodiments, this may involve identifying a target position 308 on the surface of a sphere of radius d2 centred on the second point 306. In some embodiments, this may involve identifying a target position 308 on the circle of radius d2, centred on the second point 306, and lying in a plane normal to the reference line 300 at the second point 306.

It will be appreciated that there are many ways of determining these angles (which may be seen as angles of rotations about the reference line 300). In particular, the above-described methods for the step S406 of determining the target distance d2 may be applied analogously to determining the target vector—e.g. (i) the target vector may be constrained based on the angles for the vector from the first position 304 to the current position 302; (ii) the target vector may be determined, at least in part, based on one or more properties of the object or the virtual environment; (iii) the target vector may be determined, at least in part, based on the location of other objects within, or properties of, the virtual environment; and (iv) the target vector may be determined based, at least in part, on one or more random numbers.

It will be appreciated that embodiments of the invention may be implemented using a variety of different information processing systems. In particular, although FIG. 1 and the discussion thereof provide an exemplary computing architecture and games console, these are presented merely to provide a useful reference in discussing various aspects of the invention. Of course, the description of the architecture has been simplified for purposes of discussion, and it is just one of many different types of architecture that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

As described above, the system 100 comprises a games console 102. The games console 102 may be a dedicated games console specifically manufactured for executing computer games. However, it will be appreciated that the system 100 may comprise an alternative device, instead of the games console 102, for carrying out embodiments of the invention. For example, instead of the games console 102, other types of computer system may be used, such as a personal computer system, mainframes, minicomputers, servers, workstations, notepads, personal digital assistants, and mobile telephones.

It will also be appreciated that embodiments of the invention are not limited to “computer games”, but may be used in non-game applications too. For example, embodiments of the invention may be used in driving or flight simulators, in which drivers or pilots learn to drive a car or fly an aircraft. For such applications, one or more computer-controlled vehicles may be simulated and moved within a virtual environment provided by the simulator.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of moving an object within a virtual environment of a computer game, the method comprising:
providing a reference line within the virtual environment;
based on a current position of the object relative to the reference line, determining a target position for the object relative to the reference line within the virtual environment; and
controlling the object so as to guide the object within the virtual environment towards the target position.

2. The method of claim 1, in which determining the target position comprises:
determining, based on the current position of the object within the virtual environment, a first position along the reference line corresponding to the current position;
determining, based on the first position, a second position along the reference line; and
determining the target position to be a target distance away from the second position.

3. The method according to claim 2, in which the first position along the reference line is determined to be a position along the reference line for which a straight line from the first position to the current position is perpendicular to the reference line.

4. The method according to claim 2, comprising determining a desired distance along the reference line from the first position to the second position, wherein the second position is determined to be a position along the reference line that is the desired distance along the reference line from the first position.

5. The method according to claim 4, in which determining the desired distance is dependent upon a speed of the object within the virtual environment.

6. The method according to claim 5, in which determining the desired distance is dependent upon a curvature of the reference line.

7. The method according to claim 6, in which the desired distance determined in dependence upon a first curvature is larger than the desired distance determined in dependence upon a second curvature larger than the first curvature.

8. The method according to claim 2, comprising determining the target distance.

9. The method according to claim 8, in which determining the target distance is based, at least in part, upon one or more of:
the distance between the current position and the first position;
a property of the object;
a property of the virtual environment;
the location of one or more additional objects within the virtual environment; and
a random number.

10. The method according to claim 8, in which the target distance is determined to be at most a predetermined threshold from the distance between the current position and the first position.

11. The method according to claim 2, wherein determining the target position comprises determining a target vector that starts at the second position and has a magnitude of the target distance, the target position being at the end of the target vector.

12. The method according to claim 11, in which determining the target vector is based, at least in part, upon one or more of:
the vector from the first position to the current position;
a property of the object;
a property of the virtual environment;
the location of one or more additional objects within the virtual environment; and
a random number.

13. The method of claim 1, comprising selecting the reference line from a plurality of reference lines.

14. The method of claim 1, in which providing a reference line comprises providing data defining a line along a virtual surface within the virtual environment.

15. A method of moving a plurality of objects within a virtual environment, the method comprising:
for each of the plurality of objects, carrying out the method of claim 1 to move that object.

16. A method of providing a computer game, the method comprising:
for each of a series of images for the computer game:
moving an object within a virtual environment for the computer game by carrying out a method according to claim 1;
generating that image as an image representing at least a part of the virtual environment, based at least in part on the position of the object within the virtual environment; and
outputting that image.

17. A computer readable medium storing a computer program for a computer game which, when executed by a computer, causes the computer to move an object within a virtual environment of the computer game by:
providing a reference line within the virtual environment;
based on a current position of the object relative to the reference line, determining a target position for the object relative to the reference line within the virtual environment; and
controlling the object so as to guide the object within the virtual environment towards the target position.

18. The computer readable medium of claim 17, in which determining the target position comprises:
determining, based on the current position of the object within the virtual environment, a first position along the reference line corresponding to the current position;
determining, based on the first position, a second position along the reference line; and
determining the target position to be a target distance away from the second position.

19. An apparatus arranged to move an object within a virtual environment of a computer game, the apparatus comprising:
a memory storing data defining a reference line within the virtual environment; and
a processor comprising:
a target position determination module arranged to determine a target position for the object relative to the reference line within the virtual environment based on a current position of the object relative to the reference line; and
an object moving module arranged to control the object so as to guide the object within the virtual environment towards the target position.

20. The apparatus of claim 19, in which the target position determination module is arranged to determine the target position by:
determining, based on the current position of the object within the virtual environment, a first position along the reference line corresponding to the current position;
determining, based on the first position, a second position along the reference line; and
determining the target position to be a target distance away from the second position.

21. A method of providing a computer game in which one or more objects are moved within a virtual environment of the computer game, the method comprising:
for each of a series of images to be displayed for the computer game:
for each of the one or more objects;
determining a target position for that object within the virtual environment based on the position of that object relative to a reference line within the virtual environment, there being one or more reference lines available; and
updating the current position for that object within the virtual environment to represent movement of that object towards the target position;
generating an image representing the virtual environment based, at least in part, on the updated current positions; and
displaying the generated image.

22. The method of claim 21, in which the reference line represents a line along a surface of a virtual road within the virtual environment and the one or more objects within the virtual environment represent virtual vehicles for travelling along the virtual road.

23. A computer readable medium storing a computer program which, when executed by a computer, causes the computer to provide a computer game in which one or more objects are moved within a virtual environment of the computer game by:
for each of a series of images to be displayed for the computer game:
for each of the one or more objects;
determining a target position for that object within the virtual environment based on the position of that object relative to a reference line within the virtual environment, there being one or more reference lines available; and
updating the current position for that object within the virtual environment to represent movement of that object towards the target position;
generating an image representing the virtual environment based, at least in part, on the updated current positions; and
displaying the generated image.

24. The computer readable medium of claim 23, in which the reference line represents a line along a surface of a virtual road within the virtual environment and the one or more objects within the virtual environment represent virtual vehicles for travelling along the virtual road.
